(19) United States
(12) Patent Application Publication
(10) Pub. No.: US 2004/0266385 A1
(43) Pub. Date: Dec. 30, 2004

(54) Semiconductor integrated circuit device and portable terminal system

(76) Inventors: Takeshi Uchitomi, Takasaki (JP); Akira Okasaka, Takasaki (JP); Robert Astle Henshaw, Sudbury (GB)

Correspondence Address: MATTINGLY, STANGER & MALUR, P.C., Suite 370, 1800 Diagonal Road, Alexandria, VA, 22314, US

(21) Appl. No.: 10/634,773

(22) Filed: Aug. 6, 2003

(30) Foreign Application Priority Data
Jun. 24, 2003 (GB) 0314704.8

(51) Int. Cl. H04B 1/28; H04B 15/00; H04B 1/26

(52) U.S. Cl. 455/333; 455/313; 455/323

(57) ABSTRACT

Receiving properties are greatly improved by varying and outputting an output voltage of I/Q signals, which correspond to an input level in a semiconductor integrated circuit device for baseband processing. When a portable terminals system reaches a training period after power is supplied thereto, a switch is turned on and another switch is turned off and a digital comparator compares an adjustment voltage outputted from an output-voltage adjustment circuit and a reference voltage of a baseband circuit to output comparison results thereof. A control circuit controls and adjusts, based on the comparison results, a voltage-controlled unit so that an adjustment voltage may become nearly equivalent to the reference voltage of the baseband circuit. Thereby the output level of the I signals (, Q signals) outputted from the RF processing unit is corrected, and the output levels of the I signals (, Q signals) are set to be equivalent to that of the reference voltage of the baseband circuit.

### BACKGROUND OF THE INVENTION

The present invention relates to a technique for transmitting/receiving radio signals and, more particularly, to a technique effectively applied to the improvement of the receive sensitivity of a cellular phone and the like.

In recent years, the cellular phone has been in widespread use as a device for mobile communications, and there have been increasing demands for a wide variety of functions in the cellular phone. In such cellular phone, there are generally used two semiconductor integrated circuit devices, one for RF (radio frequency) processing and one for baseband processing.

The semiconductor integrated circuit device for RF processing converts the received signals into baseband signals, and outputs them as so-called I signals and Q signals. The semiconductor integrated circuit device for baseband processing converts, into digital signals, the I signals and Q signals frequency-converted by the semiconductor integrated circuit device for RF processing, and measures each level of the digital signals to perform level control.

The input level (reference voltage) used in this semiconductor integrated circuit device for baseband processing is different in each product. Therefore, several kinds of output voltages of the I/Q signals are prepared in the semiconductor integrated circuit device for RF processing, and such output voltages are switched by program or the like to become optimum in accordance with the semiconductor integrated circuit device for baseband processing.

### SUMMARY OF THE INVENTION

However, the inventors of the present invention have found out that the following problems occur in the technique for switching the output voltages of the I/Q signals in the above-mentioned semiconductor integrated circuit device for RF processing.

The input level of the semiconductor integrated circuit device for baseband processing and the output voltage in the semiconductor integrated circuit device for RF processing are not uniform due to the manufacturing variation of the devices, respectively.

There are problems such that when the amplitude of the I/Q signals outputted from the semiconductor integrated circuit device for RF processing exceeds the allowable limit of an input dynamic range of the semiconductor integrated circuit device for baseband processing due to the manufacturing variation, the receiving properties or the like of the cellular phone deteriorate.

Also, it is necessary to define the spec of the semiconductor integrated circuit device for RF processing by taking electric properties into consideration in order to prevent the large deterioration of the receiving properties, and so there is the possibility that the yield of the semiconductor integrated circuit device for RF processing will deteriorate.

An object of the present invention is to provide a semiconductor integrated circuit device and a portable terminal system capable of greatly improving the receiving properties, by changing and outputting the output voltage of the I/Q signals so as to correspond to the input level of the semiconductor integrated circuit device for baseband processing.

The above and other objects and novel characteristics of the present invention will be apparent from the description of the specification and the accompanying drawings.

The typical ones of the inventions disclosed in this application will be briefly described as follows.

(1) An aspect of the present invention is a semiconductor integrated circuit device for RF processing, which frequency-converts a received signal into a baseband to output the signal as an I signal and a Q signal, comprising: an external input terminal to which an adjustment signal, giving instructions to adjust output-voltage levels of said I signal and Q signal, is inputted.

Also, the outline of other inventions in this application will be described in brief.

(2) Another aspect of the present invention is a semiconductor integrated circuit device for baseband processing, which converts, into a digital signal, the I signal and Q signal frequency-converted by the semiconductor integrated circuit device for RF processing and measures a level of the digital signal to perform level control, comprising: an external output terminal for outputting an adjustment signal giving instructions to adjust output-voltage levels of said I signal and Q signal.

(3) Another aspect of the present invention is a portable terminal system comprising: a first semiconductor-integrated circuit device for RF processing, which frequency-converts a received signal into a baseband to output the signal as an I signal and a Q signal; and a second semiconductor integrated circuit device for baseband processing, which converts, into a digital signal, the I signal and Q signal frequency-converted by the first semiconductor integrated circuit device and measures a level of the digital signal to perform level control, wherein said first semiconductor integrated circuit device includes an external input terminal to which an adjustment signal, giving instructions to adjust output-voltage levels of the I signal and Q signal, is inputted, and the second semiconductor integrated circuit device includes an external output terminal for outputting the adjustment signal to the external input terminal of the first semiconductor integrated circuit device.

### BRIEF DESCRIPTION OF THE DRAWINGS

FIG. 1 is a block diagram of a mobile communication system according to an embodiment of the present invention.

FIG. 2 is an explanatory diagram showing a circuit configuration of an RF processing unit and a baseband circuit in the mobile communication system shown in FIG. 1.

FIG. 3 is an explanatory diagram showing an example of a circuit configuration of a voltage-controlled unit provided in the output-voltage adjustment circuit in FIG. 2.

FIG. 4 is a circuit diagram showing an example of an A/D converter provided in the baseband circuit in FIG. 2.

FIG. 5 is a transition diagram showing the state of the voltage control-adjustment in the output-voltage adjustment circuit in FIG. 2.

FIG. 6 is an explanatory diagram showing an example of the output waveform of the I signals/Q signals examined by the inventors as a comparison example.

FIG. 7 is a diagram showing an example of the output waveform of the I signals/Q signals outputted from the RF processing unit in FIG. 2.

FIG. 8 is an explanatory diagram showing the circuit configuration of a RF processing unit and a baseband circuit according to another embodiment of the present invention.

### DESCRIPTION OF THE PREFERRED EMBODIMENTS

Hereinafter, an embodiment of the present invention will be described in detail with reference to the accompanying drawings.

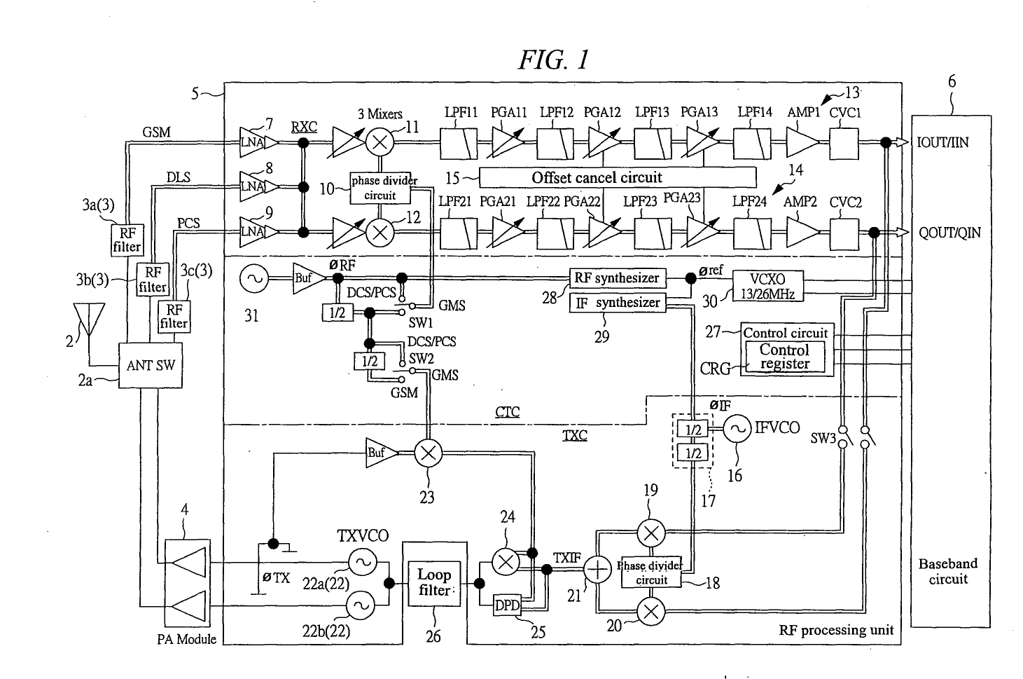

FIG. 1 is a block diagram of a mobile communication system according to an embodiment of the present invention;

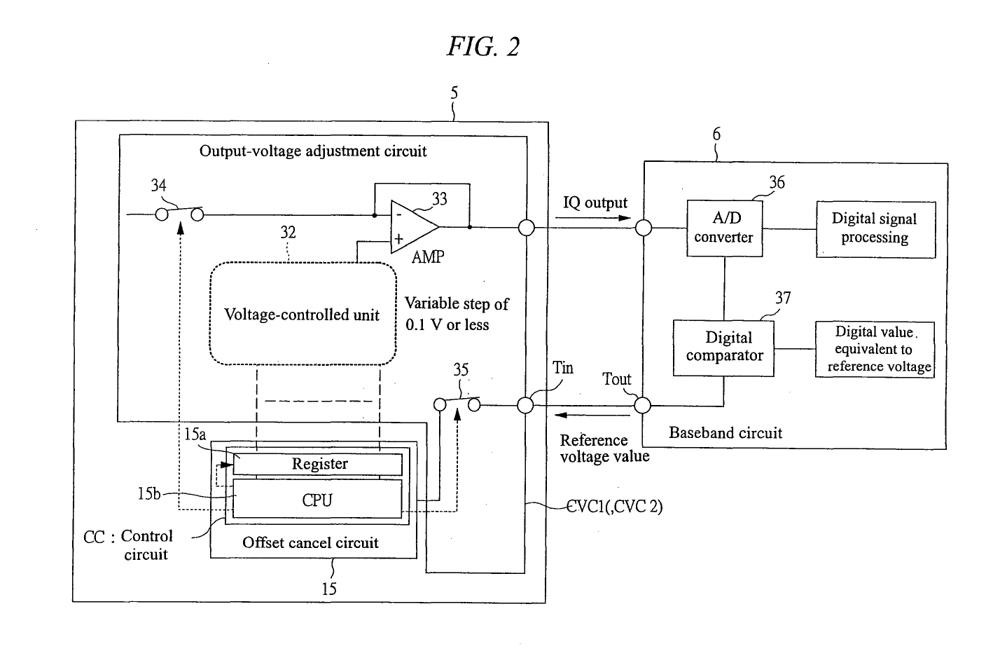

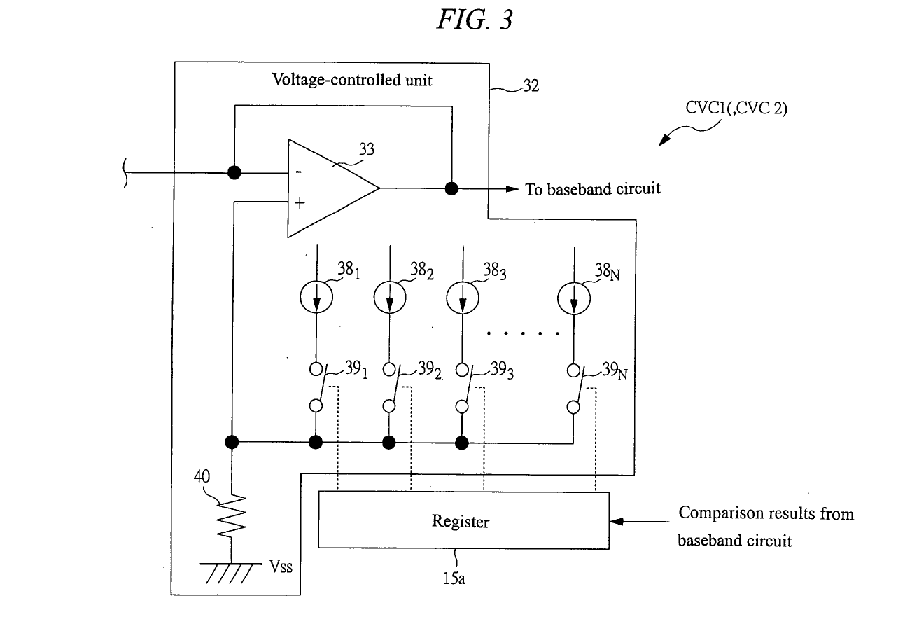

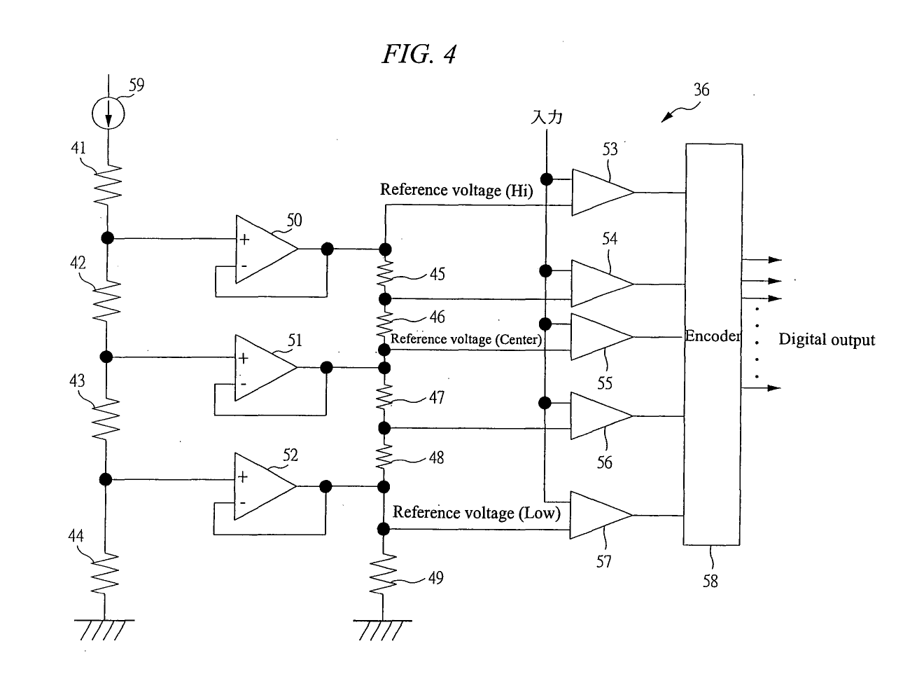

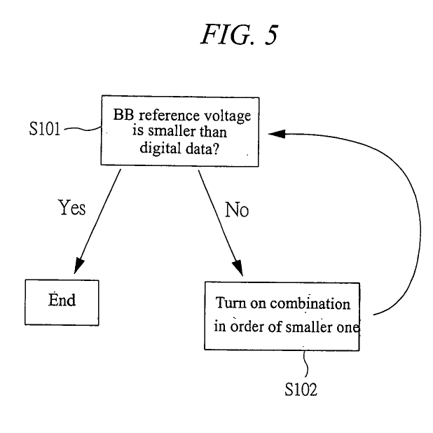

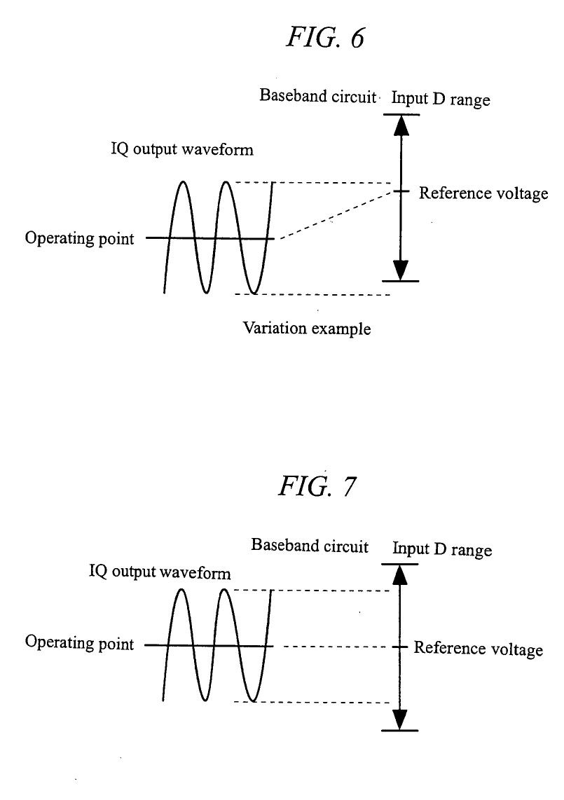

FIG. 2 is an explanatory diagram showing a circuit configuration of an RF processing unit and a baseband circuit in the mobile communication system in FIG. 1; FIG. 3 is an explanatory diagram showing an example of a circuit configuration of a voltage-controlled unit provided in the output-voltage adjustment circuit in FIG. 2; FIG. 4 is a circuit diagram showing an example of an A/D converter provided in the baseband circuit in FIG. 2; FIG. 5 is a transition diagram showing the state of the voltage control-adjustment in the output-voltage adjustment circuit in FIG. 2; FIG. 6 is an explanatory diagram showing an example of the output waveform of the I signal/Q signal examined as a comparative example by the inventors; and FIG. 7 is a diagram showing an example of the output waveform of the I signal/Q signal outputted from the RF processing unit in FIG. 2.

In this embodiment, a mobile communication system (portable communication system) 1 is, for example, a communication system such as a cellular phone. As shown in FIG. 1, this mobile communication system 1 comprises a transmitting/receiving antenna 2, an antenna switch 2a, RF filters 3, an RF power amplifier circuit 4, an RF processing unit (semiconductor integrated circuit device, first semiconductor integrated circuit) 5, a baseband circuit (semiconductor integrated circuit device, second semiconductor integrated circuit) 6 and the like.

The antenna 2 transmits and/or receives signal waves. The antenna switch 2a switches the transmitted/received signals. Each of the RF filters 3 includes: an SAW filter for removing the unnecessary waves from the received signals; and the like.

The RF power amplifier circuit 4 amplifies the transmitted signals. The RF processing unit 5 demodulates the received signals and/or modulates the transmitted signals. This RF processing unit 5 is constituted as a semiconductor integrated circuit device on one semiconductor chip. The baseband circuit 6 converts transmit data into I signals and/or Q signals, and controls the RF processing unit 5.

Though not particularly limited, the RF processing unit 5 has a configuration such that the signals based on the four communication systems of GSM850, GSM900, DCS1800, and PCS1900 can be modulated/demodulated.

Also, according to this, the RF filters 3 is provided with: a filter 3a passing through the received signals within a frequency band of the GSM series; a filter 3b passing through the received signals within a frequency band of the DCS1800; and a filter 3c passing through the received signals within a frequency band of the PCS 1900. Since the GSM850 and the GSM950 have frequency bands close to each other, the signals within them are filtered by the common filter 3a in this case.

Further, the RF processing unit 5 roughly includes: a receiver system circuit RXC; a transmitter system circuit TXC; and a controller system circuit CTC comprising a circuit common to a transmitter/receiver system circuit such as a controller circuit and a clock system circuit, etc. other than them.

The receiver system circuit RXC includes low-noise amplifiers 7 to 9, a phase divider circuit 10, mixer circuits 11 and 12, high-gain amplifier sections 13 and 14, an offset cancel circuit 15, and the like.

The low-noise amplifiers 7 to 9 are amplifiers for amplifying the received signals. The phase divider circuit 10 divides oscillator signals φRF generated in a later-described RF oscillator circuit (RFVCO) 31, thereby generating orthogonal signals having a 90 degrees phase shift with respect to each other.

The mixer circuits 11 and 12 are demodulator circuits for performing the demodulation by combining the orthogonal signals divided in the divider circuit 10 and the received signals amplified in the low-noise amplifiers 7 to 9. The high-gain amplifier sections 13 and 14 amplify the demodulated I and Q signals, respectively, to output them to the baseband circuit 6. The offset cancel circuit 15 cancels the input DC offset of the amplifiers in the high-gain amplifier sections 13 and 14.

The high-gain amplifier section 13 comprises low-path filters LPF11, LPF12, LPF13 and LPF14, gain-control amplifiers PGA11, PGA12 and PGA13, an amplifier AMP1, and an output-voltage adjustment circuit (voltage-output adjustment section) CVC1, wherein the I signals are amplified and outputted to the baseband circuit 6.

These low-path filters LPF11, LPF12, LPF13 and LPF14 and the gain-control amplifiers PGA11, PGA12 and PGA13 are alternately connected in series, and the amplifier AMP1 having a fixed gain is connected at the output thereof.

The output-voltage adjustment circuit CVC1 is connected to the subsequent output stage of the amplifier AMP1. The output-voltage adjustment circuit CVC1 varies the output voltage of the I signals based on the control signals outputted from the baseband circuit 6.

Similarly, the high-gain amplifier section 14 also comprises low-path filters LPF21, LPF22, LPF23 and LPF24, gain-control amplifiers PGA21, PGA22 and PGA23, an amplifier AMP2, and an output-voltage adjustment circuit (voltage-output adjustment section) CVC2, wherein the Q signals are amplified and outputted to the baseband circuit 6.

These low-path filters LPF21, LPF22, LPF23 and LPF24 and the gain-control amplifiers PGA21, PGA22 and PGA23 are alternately connected in series, and the amplifier AMP2 having a fixed gain is connected at the subsequent output stage thereof.

Further, the output-voltage adjustment circuit CVC2 is connected to the subsequent output stage of the amplifier AMP2. The output-voltage adjustment circuit CVC2 varies the output voltage of the Q signals based on the control signals outputted from the baseband circuit 6.

The offset cancel circuit 15 comprises: multiple A/D (analog/digital) converters which are connected respectively to the gain control amplifiers PGA11 to PGA23 and which convert into digital signals, the differential DC offsets present at the output of each gain control amplifier when the input terminals of that amplifier are short-circuited; D/A (digital/analog) converter circuits, which generate such input-offset voltage as to control, to the value “0”, the corresponding DC offset in the outputs of the gain-control amplifiers PGA11 to PGA23 based on the conversion results by the A/D converter circuits and which gives the generated input-offset voltage to the differential input; a control circuit CC (FIG. 2) for controlling the A/D converter circuits and the D/A converter circuits to perform their offset cancel operations; and the like.

The transmitter circuit TXC comprises an oscillator circuit (IFVCO) 16, a divider circuit 17, a phase divider circuit 18, modulator circuits 19 and 20, an adder 21, an oscillator circuit for transmission (TXVCO) 22, an offset mixer 23, an analog phase comparator 24, a digital phase comparator 25, a loop filter 26, and the like.

The oscillator circuit (IFVCO) 16 generates oscillator signals φIF with an intermediate frequency of, for example, about 640 MHz. The divider circuit 17 divides, into ¼, the oscillator signals φIF generated in the oscillator circuit 16 and generates the signals with a frequency of about 160 MHz.

The phase divider circuit 18 further divides the signal divided in the above-mentioned divider circuit 17, and generates the orthogonal signals having a 90 degrees phase shift with respect to each other. The modulator circuits 19 and 20 modulate the generated orthogonal signals by the use of the I and Q signals supplied from the baseband circuit 6.

The adder 21 combines the modulated signals. The oscillator circuit for transmission (TXVCO) 22 generates transmitted signals φTX with a predetermined frequency. The offset mixer 23 combines feedback signals, which are obtained by extracting the transmitted signals φTX outputted from the oscillator circuit for transmission 22 through a coupler etc., and signals φRF′obtained by dividing the oscillator signals φRF generated in the RF oscillator circuit 31, thereby generating signals with a frequency equivalent to the frequency difference therebetween.

The analog phase comparator 24 and the digital phase comparator 25 compare the output of the offset mixer 23 and signals TXIF combined by the adder 21 to detect the phase difference. The loop filter 26 generates the voltage corresponding to the outputs of the phase detection circuits 24 and 25.

Note that resistors and capacitors, constituting the loop filter 26, are connected as external elements to the external terminals of the RF processing unit 5. The oscillator circuit for transmission 22 comprises an oscillator circuit 22a generating transmitted signals of the GSM850 and GSM900, and an oscillator circuit 22b generating transmitted signals of the DCS1800 and PCS1900.

The reason why two oscillator circuits are provided is that the oscillator circuit for transmission has a wider variable frequency range in comparison with the RF oscillator circuit 31 and the intermediate-frequency oscillator circuit 16 but it is difficult to design a circuit capable of covering the entire frequency range with one oscillator circuit.

The analog phase comparator 24 and the digital phase comparator 25 are provided because of obtaining the quick pulling operation at the time of starting up a PLL circuit. More precisely, at the start of the transmission, the phase comparison is first performed by the digital phase comparator 25, and then the above comparator 25 is switched to the analog phase comparator 24, thereby allowing the phase loop to lock rapidly.

Also, a control circuit 27, an RF synthesizer 28, an IF synthesizer 29, and a reference oscillator circuit (VCXO) 30 are provided on a chip of the RF processing unit 5.

The control circuit 27 performs the overall control of the chip. The RF synthesizer 28 comprises an RF PLL circuit together with the RF oscillator circuit 31. The IF synthesizer 29 comprises an IF PLL circuit together with the intermediate-frequency oscillator circuit 16. The reference oscillator circuit 30 generates clock signals φref to be reference signals for the RF synthesizer 28 and the IF synthesizer 29.

The RF synthesizer 28 and the IF synthesizer 29 each comprise a phase comparator circuit, a charge pump, a loop filter, and the like. Note that since high frequency accuracy is required in the reference oscillator signals φref, a crystal resonator is externally connected to the reference oscillator circuit 30. Signals with a frequency of 26 MHz or 13 MHz are selected as the reference oscillator signals φref. This is because the crystal resonator for such frequencies can be obtained at relatively low cost.

In FIG. 1, blocks denoted by a fraction number such as ½ or ¼ respectively represent divider circuits, and those denoted by the symbol “Buf” represent buffer circuits. Also, SW1 and SW2 denote switches for switching the connection states between a GSM mode performing the transmission/reception in accordance with the GSM method and a DCS/PCS mode performing the transmission/reception in accordance with the DCS or PCS method to select the dividing ratio of the signals to be transmitted.

SW3 denotes a switch controlled to be turned on and off to supply the I and Q signals from the baseband circuit 6, to the modulation mixers 19 and 20, at the time of the transmission. These switches SW1 to SW3 are controlled based on the signals from the control circuit 27.

The control circuit 27 is provided with a control register CRG, and the setting of the register CRG is done based on the signals from the baseband circuit 6. More specifically, clock signals CLK for synchronization, data signals SDATA, and load enable signals LEN as control signals are supplied to the RF processing unit 5 from the baseband circuit 6. When the load enable signals LEN are asserted to an effective level, the control circuit 27 sequentially takes in the data signals SDATA transmitted from the baseband circuit 6 in synchronization with the clock signals CLK and sets them to the control register CRG. Though not particularly limited, the data signals SDATA are transmitted in serial form. The baseband circuit 6 comprises a microprocessor and the like.

Though not particularly limited, the control register CRG is provided with: a control bit for starting the frequency measurement of the VCO in the RF oscillator circuit (RFVCO) 31 and the intermediate-frequency oscillator circuit 16; and a bit field for designating a mode such as a receive mode, a transmission mode, a idling mode, and a warm-up mode, etc.

In this case, the idling mode is a mode of coming to a sleep state, in which only a few circuits are operated and most of the circuits including at least the oscillator circuit are stopped, at the awaiting time or the like. The warm-up mode is a mode for starting-up the PLL circuit just before the transmission or reception.

In this embodiment, the phase detection circuits 24 and 25, the loop filter 26, the oscillator circuits for transmission 22a and 22b, and the offset mixer 23 constitute the PLL circuit for transmission (TXPLL) that performs the frequency conversion.

In the mobile communication system 1 employing the multi-band method according to this embodiment, by instructions from the baseband circuit 6 for example, the control circuit 27 changes the frequency φRF of the oscillator signals of the RF oscillator circuit 31 at the time of transmission/reception in accordance with the channel to be used; and by switching the above switch SW2 depending on the GSM mode or the DCS/PCS mode, the frequency of the signals supplied to the offset mixer 23 is changed to perform the switching of the transmission frequency.

In any cases of GSM, DCS, and PSC, the oscillation frequency of the intermediate-frequency oscillator circuit 16 is set at 640 MHz and this is divided into ⅛ by the divider circuit 17 and the phase divider circuit 18, whereby a 80 MHz carrier wave (TXIF) is generated to perform the modulation.

Meanwhile, the oscillation frequency of the RF oscillator circuit 31 is set at different values depending on the receive mode and the transmit mode. The oscillation frequency fRF of the RF oscillator circuit 31 in the receive mode is set, for example, at 3616 to 3716 MHz in the case of the GSM850, at 3840 to 3980 MHz in the case of the GSM900, at 3610 to 3730 MHz in the case of the DCS, and at 3860 to 3980 MHz in the case of the PCS. This is divided into ¼ by the divider circuit in the case of the GSM and into ½ in the cases of the DCS and PCS, thereby being supplied to the offset mixer 23 as the signals φRF′.

The offset mixer 23 outputs signals with the frequency equivalent to the difference (fRF′-fTX) in frequency between the signals φRF′ and the transmission oscillator signals φTX from the oscillator circuit for transmission 4, and the transmission PLL (TXPLL) is operated so that the frequency of the difference signals corresponds to that of the modulation signals TXIF.

In other words, the oscillator circuit for transmission 22 is locked to a frequency which is the difference between the frequency (fRF/4) of the oscillator signals φRF′ from the RF oscillation circuit 31 and the frequency (fTX) of the modulation signals TXIF. This transmission system is generally termed an offset phase locked loop.

Also, the circuit configurations of the output-voltage adjustment circuit CVC1 (, CVC2) of the RF processing unit 5 and of a correction instruction unit provided in the baseband circuit 6, and the connection structure thereof will be described with reference to FIG. 2.

The RF processing unit 5 is provided with an external input terminal Tin, to which adjustment signals are inputted from the outside, and the baseband circuit 6 is provided with an external output terminal Tout, from which the above adjustment signals are outputted.

The output-voltage adjustment circuit CVC1 (, CVC2) comprises a voltage-controlled unit (voltage generator unit) 32, an amplifier (amplifier unit) 33, and switches 34 and 35. Furthermore, the correction instruction unit provided in the baseband circuit 6 includes an A/D converter 36 and a digital comparator (comparator unit) 37.

The A/D converter 6 converts the I signals (, Q signals) outputted from the amplifier 33 or the output voltage of the I signals (, Q signals), into digital data. The digital comparator 37 compares the digital data outputted from the A/D converter 36 and the reference voltage, and outputs, as the adjustment signals, the comparison results (adjustment signals) to the outside from the external output terminal Tout. The comparison results outputted from the external output terminal Tout are inputted to the output-voltage adjustment circuit CVC1 (, CVC2) via the external input terminal Tin in the RF processing unit 5.

The reference voltage inputted to the digital comparator 37 has a value obtained by converting the intermediate-level reference voltage (Center) generated in the A/D converter 36 described later in FIG. 4, into the digital data.

The voltage-controlled unit 32 outputs the set voltage, which is varied on the basis of the setting value of a register (storage unit) 15a provided in the control circuit (control unit) CC in the offset cancel circuit 15. For example, this set voltage is a voltage varied in a step of about 0.1 V or less.

Also, the setting of data to the register 15a is performed by a CPU 15b provided in the control circuit CC of the offset cancel circuit 15. The CPU 15b performs the setting of the data to the register 15a based on the comparison results outputted from the digital comparator 37 described later.

The amplifier 33 outputs a output voltage with a voltage level nearly equivalent to the voltage level of its positive (+) side input terminal. The positive (+) side input terminal of the amplifier 33 is connected to the output terminal of the voltage-controlled unit 32. The output terminal and negative (−) side input terminal of the amplifier 33 are connected together and are connected to one terminal of the switch 34. Further, the output terminal of the amplifier 33 is connected to the input of the A/D converter 36 provided in the baseband circuit 6.

The output of the amplifier AMP1 (, AMP2) in the preceding stage is connected to the other terminal of the switch 34. The switch 34 performs switching of the signal outputted from the amplifier AMP1 (, AMP2).

The control circuit CC is connected to one terminal of the switch 35, and the digital comparator 37 provided in the baseband circuit 6 is connected to the other terminal of the switch 35. The switch 35 controls the input of the comparison results outputted from the digital comparator 37.

The control circuit CC controls the ON/OFF of these switches 34 and 35. The switch 34 is turned off, during a training period before reaching a receive period, after power is supplied into the mobile communication system 1, thereby shutting out the output signals outputted from the amplifier AMP1 (, AMP2). After the above-mentioned training period, the switch 34 is turned on.

The switch 35 is turned on during the training period to output the comparison results outputted from the digital comparator 37 to the control circuit CC. After the above-mentioned training period, the switch 35 is turned off.

Also, in the baseband circuit 6, the A/D converter 36 converts the I signals (, Q signals) outputted from the amplifier 33, into digital data. The digital data outputted from the A/D converter 36 and the reference voltage of the baseband circuit 6 are respectively inputted to the digital comparator 37. The digital comparator 37 compares the digital data from the A/D converter 36 and the reference voltage, and outputs its comparison results.

Further, the circuit configuration of the voltage-controlled unit 32 in the output-voltage adjustment circuit CVC1 (, CVC2) will be described with reference to FIG. 3.

The voltage-controlled unit 32 comprises power sources 38₁ to 38_{N}, switches 39₁ to 39_{N}, and a resistor 40. The power sources 38₁ to 38_{N} are respectively connected to one connecting portions of the switches 39₁ to 39_{N}.

The other connecting portions of the switches 39₁ to 39_{N} are commonly connected to one connecting portion of the resistor 40 and the positive side input terminal of the amplifier 33, and a reference voltage (VSS) is connected to the other connecting portion of the resistor 40.

The power sources 38₁ to 38_{N} are set so that each current value thereof can be doubled, for example, is 10 μA, 20 μA, 40 μA, 80 μA . . . . The register 15a performs on and off control of the switches 39₁ to 39_{N}.

The register 15a selects any one of the switches 39, to 39_{N} and turns on the selected switch. The current outputted from the optional power source through the selected switch is converted into voltage by the resistor 40 and is inputted to the positive side input terminal of the amplifier 33.

Also, FIG. 4 is a diagram showing the circuit configuration of the A/D converter 36.

The A/D converter 36 includes resistors 41 to 49, amplifiers 50 to 52, comparators 53 to 57, an encoder 58, and a power source 59.

The resistors 41 to 44 are connected in series between the power source 59 supplying a current with a certain value and the reference voltage. Also, the resistors 45 to 49 are connected in series between the other input part of the comparator 53 and the reference voltage.

The positive (+) side input terminals of the amplifiers 50 to 52 are respectively connected respectively to the junctions between the resistors 41 and 42, between resistors 42 and 43, and between the resistors 43 and 44.

The negative (−) side input terminal of the amplifier 50, one connection terminal of the resistor 45, and one input terminal of the comparator 53 are connected to the output terminal of the amplifier 50. The negative side input terminal of the amplifier 51 and the connection terminals of the resistors 46 and 47 are connected to the output terminal of the amplifier 51. The negative side input terminal of the amplifier 52 and one connection terminal of the resistor 49 are connected to the output terminal of the amplifier 52.

The one input terminals of the comparators 53 to 57 are connected so that the I signals (, Q signals) outputted from the RF processing unit 5 are inputted. Each connection terminal of the resistors 45 and 46 is connected to the other input terminal of the comparator 54, and each connection terminal of the resistors 46 and 47 is connected to the other input terminal of the comparator 55.

Also, each connection terminal of the resistors 47 and 48 is connected to the other input terminal of the comparator 56. Each connection terminal of the resistors 48 and 49 is connected to the other input terminal of the comparator 57.

The respective voltages divided by the resistors 41 to 44 are outputted via the amplifiers 50 to 52 and are inputted to the other input terminals of the comparators 53, 55, and 57.

The voltage outputted from the amplifier 50 becomes the highest reference voltage (Hi), and the voltage outputted from the amplifier 51 becomes the intermediate level reference voltage (Center). The voltage outputted from the amplifier 52 becomes the lowest reference voltage (Lo).

Further, the voltages divided by the resistors 45 and 46 and the voltages divided by the resistors 47 and 48 are inputted to the other input parts of the comparators 54 and 56 as reference voltages, respectively.

Thus, the five reference voltages each having different level are respectively inputted to the comparators 53 to 57, and the comparators 53 to 57 compare the I signals (, Q signals) outputted from the RF processing unit 5 and the reference voltages, outputting the comparison results to the encoder 58.

The encoder 85 encodes the comparison results outputted from the comparators 53 to 57, and outputs them as digital data used in the digital signal processing, to the circuits in the subsequent stage and to the digital comparator 37.

Next, the operations of the RF processing unit 5 and the baseband circuit 6 according to this embodiment will be described.

First, when the mobile communication system 1 reaches the training period after power is supplied thereto, the control circuit CC turns off the switch 34 and turns on the switch 35 to shut out the signals outputted from the amplifier AMP1 (, AMP2) and allows the digital comparator 37 to be conductive.

The A/D converter 36 converts, into the digital data, the adjustment voltage outputted from the output-voltage adjustment circuit CVC1 (, CVC2), and outputs it to the digital comparator 37.

The digital comparator 37 compares the digital data outputted from the A/D converter 36 and the reference voltage, and outputs the comparison results to the control circuit CC. The control circuit CC varies and adjusts the voltage based on the comparison results of the digital comparator 37 so that the digital data of the A/D converter 36 may become nearly equivalent to the reference voltage of the baseband circuit 6.

The voltage control-adjustment in the output-voltage adjustment circuit CVC1 (, CVC2) will be described with reference to the transition diagram in FIG. 5.

The CPU sets the data of the register 15a to turn on the switch 39₁ and to carry only the current from the power source 38₁ with the lowest current value. A voltage, generated across register 40 due to the current flowing from the current source 38₁ via the switch 39₁, is inputted to the positive (+) input terminal of the amplifier 33.

The amplifier 33 outputs a voltage nearly equal to the voltage present at the positive (+) input terminal, to the A/D converter 36 of the baseband circuit 6. The A/D converter 36 converts the inputted voltage into the digital data and outputs it to the digital comparator 37.

The digital comparator 37 compares the reference voltage of the baseband circuit 6 setting the input level and the digital data outputted from the digital comparator 37, and outputs the comparison results to the control circuit CC.

Then, when the reference voltage of the baseband circuit 6 is smaller than the digital data of the digital comparator 37 (step S101), the CPU resets the data of the register 15a to turn on the switch 39₂ and carry the current from the power source 38₂ higher in current value than the power source 38₁ (step S102).

The control circuit CC repeats the processes of the steps S101 and S102 until the reference voltage of the baseband circuit 6 becomes higher than the digital data of the digital comparator 37, and the above-mentioned processes are finished when the reference voltage becomes higher than the digital data of the digital comparator 37.

In this way, the output level of the I signal (, Q signal) is adjusted until it is nearly equal to the reference voltage (input level) in the baseband circuit 6.

Thereafter, when the training period is finished, the control circuit CC turns on the switch 34 so that the I signals (, Q signals) outputted from the amplifier AMP1 (, AMP2) may be inputted to the negative side input terminal of the amplifier 33. At the same time, the control circuit CC turns off the switch 35 to shut out the comparison results from the digital comparator 37, whereby the normal receiving period is started.

This embodiment is arranged to have the switches 33 and 34. However, the embodiment may be realized by means of software without providing the switches 33 and 34 therein, for example, processed so that: the signals outputted from the digital comparator 37 are made effective and the signals outputted from the amplifier AMP1 (, AMP2) are made ineffective during the training period; and the signals outputted from the digital comparator 37 are made ineffective and the signals outputted from the amplifier AMP1 (, AMP2) are made effective after the training period.

Also, FIG. 6 is an explanatory diagram showing an example of the output waveform of the I signals/Q signals examined as a comparison example by the inventors, and FIG. 7 is a diagram showing an example of the output waveform of the I signals/Q signals outputted from the RF processing unit 5 according to this embodiment.

For example, as shown in FIG. 6, even if the output level of the I signal/Q signal does not correspond to the reference voltage of the baseband circuit 6 due to the manufacturing variation etc., then the I signals/Q signals are outputted to the baseband circuit 6 without any changes in the absence of the output-voltage adjustment circuit CVC1 (, CVC2). Therefore, the I signal/Q signals exceed the allowable limit of the input dynamic range of the baseband circuit 6, and there is the possibility that the receiving properties will deteriorate.

However, as shown in FIG. 7, if the output level of the I signals/Q signals is adjusted and outputted by the output-voltage adjustment circuit CVC1 (, CVC2) so as to correspond to the reference voltage of the baseband circuit 6, then the output level is within the allowable limit of the input dynamic range of the baseband circuit 6, thereby allowing for obtaining the preferable receiving properties.

Consequently, according to this embodiment, the output-voltage adjustment circuits CVC1 and CVC2 can improve the receiving properties of the mobile communication system 1, by adjusting the output level of the I signals/Q signals during the training period so as to correspond to the reference voltage of the baseband circuit 6.

Additionally, the RF processing unit 5 can be used without any problems even if the output level of the I signals/Q signals varies due to manufacturing tolerances. Therefore, it is possible to improve the manufacturing yield of the RF processing unit 5 and reduce the manufacturing cost of the mobile communication system 1.

In the foregoing text, the system devised by the inventors has been described based on one particular embodiment. However, the invention is not limited in any way to the embodiment which has been described and may be modified and altered as necessary based on the fundamental underlying technique.

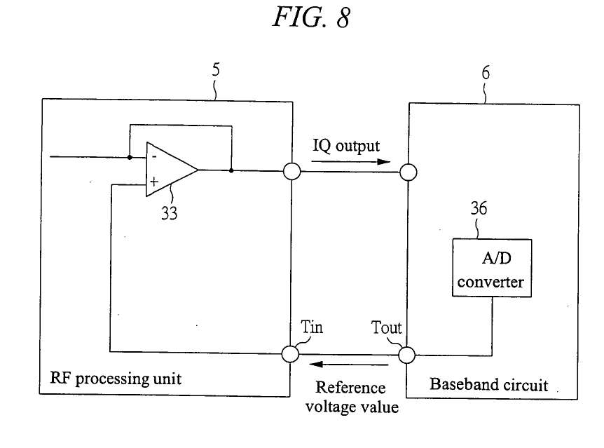

For example, the output level of the I signals/Q signals of the RF processing unit is adjusted by the feedback control so as to correspond to the reference voltage of the baseband circuit in the foregoing embodiment. However, as shown in FIG. 8, it is also possible to directly input the reference voltage of the baseband circuit 6 to the positive side input terminal of the amplifier 33 of the RF processing unit 5.

The reference voltage (Center) generated in the A/D converter 36 is used as the reference voltage of the baseband circuit 6, and the reference voltage (Center) is outputted, from the external output terminal Tout provided in the baseband circuit 6, and is inputted via the external input terminal Tin provided in the RF processing unit 5.

In this case, it is possible to adjust the output level of the I signals/Q signals of the RF processing unit 5 so as to correspond to the reference voltage (Center).

Also in this manner, it is possible to improve the receiving properties of the mobile communication system 1 and to reduce the manufacturing cost thereof. Additionally, the output-voltage adjustment circuits CVC1 and CVC2 (FIG. 2) are not required, thereby allowing for reducing the size of the RF processing unit 5 and to achieve the cost reduction thereof.

The advantages achieved by the typical ones of the inventions disclosed in this application will be briefly described as follows.

(1) The output level of the I signals/Q signals can be adjusted accurately and rapidly.

(2) Also, the semiconductor integrated circuit device for RF processing, even if the output level of the I signals/Q signals thereof exceeds the allowable limit due to the manufacturing variation, can be used without any problems, allowing for reducing the manufacturing yield of the semiconductor integrated circuit device.

(3) Items (1) and (2) described above can improve the receiving properties of the mobile communication system and also reduce the manufacturing cost of the mobile communication system.

What is claimed is:

1. A semiconductor integrated circuit device for RF processing, which frequency-converts a received signal into a baseband to output the signal as an I signal and a Q signal, comprising:
an external input terminal to which an adjustment signal, giving instructions to adjust output-voltage levels of said I signal and Q signal, is inputted.

2. The semiconductor integrated circuit device according to claim 1, further comprising an output-voltage adjustment unit for adjusting the output-voltage levels of the I signal and the Q signal, based on an adjustment signal inputted via said external input terminal.

3. The semiconductor integrated circuit device according to claim 2,
wherein said output-voltage adjustment unit comprises:
a control unit for outputting control data based on the instructions of said adjustment signal;
a storage unit for storing the control signal of said control unit;
a voltage generator unit for carrying a current with an optional current value among a plurality of different current values and converting the current into an optional voltage, based on the control signal stored in said storage unit; and
an amplifier for outputting a value of the voltage converted by said voltage generator unit, as the output voltage levels of the I signal and Q signal.

4. The semiconductor integrated circuit device according to claim 3,
wherein the voltage outputted from said voltage generator unit is changed in a step of about 0.1 V or less.

5. A semiconductor integrated circuit device for RF processing, which frequency-converts a received signal into a baseband to output the signal as an I signal and a Q signal, comprising:
an external input terminal to which a reference voltage, giving the instructions for adjusting output-voltage levels of said I signal and Q signal, is inputted; and
an amplifier for adjusting the output-voltage levels of said I signal and Q signal, based on the reference voltage inputted via said external input terminal.

6. A semiconductor integrated circuit device for baseband processing, which converts, into digital signals, an I signal and a Q signal frequency-converted by a semiconductor integrated circuit device for RF processing and measures levels of the digital signals to perform level control, comprising:
an external output terminal for outputting an adjustment signal giving instructions to adjust output-voltage levels of said I signal and Q signal.

7. The semiconductor integrated circuit device according to claim 6, further comprising:
an A/D converter for converting, into digital data, an output-voltage level outputted from the outside; and
a comparison unit for comparing the digital data outputted from said A/D converter and a reference voltage, and for outputting the comparison results as an adjustment signal.

8. A portable terminal system, comprising:
a first semiconductor integrated circuit device for RF processing, which frequency-converts a received signal into a baseband to output the signal as an I signal and a Q signal; and
a second semiconductor integrated circuit device for baseband processing, which converts, into digital signals, the I signal and Q signal frequency-converted by said first semiconductor integrated circuit device and measures levels of the digital signals to perform level control,
wherein said first semiconductor integrated circuit device includes an external input terminal to which an adjustment signal, giving instructions to adjust output-voltage levels of said I signal and Q signal, is inputted, and wherein said second semiconductor integrated circuit device includes an external output terminal for outputting said adjustment signal to the external input terminal of said first semiconductor integrated circuit device.

9. The portable terminal system according to claim 8,
wherein said first semiconductor integrated circuit device includes:
an output voltage adjustment unit for adjusting the output voltage levels of the I signal and the Q signal, based on the adjustment signal inputted via said external input terminal, and
said second semiconductor integrated circuit device includes:
an A/D converter for converting, into digital data, an output-voltage level outputted from the outside; and
a comparison unit for comparing the digital data outputted from said A/D converter and a reference voltage and for outputting the comparison results as an adjustment signal.

10. The potable terminal system according to claim 9,
wherein the output-voltage adjustment unit of said first semiconductor integrated circuit device includes:
a control unit for outputting control data based on instructions of said adjustment signal;
a storage unit for storing the control signal of said control unit;
a voltage generator unit for carrying a current with an optional current value among a plurality of different current values and for converting the current into an optional voltage, based on the control signal stored in said storage unit; and
an amplifier for outputting a value of the voltage converted by said voltage generator unit, as output-voltage levels of said I signal and Q signal.

11. The portable terminal system according to claim 10,
wherein the voltage outputted from said voltage generator unit is changed in a step of about 0.1 V or less.
